(19) United States
(12) Patent Application Publication
(10) Pub. No.: US 2011/0004653 A1
(43) Pub. Date: Jan. 6, 2011

(54) METHOD FOR ACTIVATION OF A MEDIA PROCESSING DEVICE TO A WEB SERVER

(76) Inventors: Barry Richard Cavill, Versilles, KY (US); Larry John Dicken, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/497,893

(22) Filed: Jul. 6, 2009

(51) Int. Cl. G06F 15/16

(52) U.S. Cl. 709/203

(57) ABSTRACT

A method for activating a media processing device to a web server by a data processing device is disclosed. A device registration request is provided to the web server. The device registration request comprises information specific to the media processing device. An activation code is retrieved from the web server based on the information specific to the media processing device. The activation code is provided to the media processing device for triggering the activation of the media processing device. The activation code is forwarded by the media processing device to the web server and the media processing device is registered and activated on confirmation of the activation code by the web server.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Disclosure

The disclosure relates generally to media processing devices, and, more particularly, to activation of a media processing device to a web server.

2. Description of the Related Art

Media processing devices are widely used in offices, in homes and in business enterprises. The media processing devices as used herein may encompass printing systems, such as color and black-and-white printing systems, and so-called ‘all-in-one devices’ that incorporate multiple functions, such as scanning, copying, and printing capabilities in one device. Nowadays, an increasing number of the media processing devices are being configured to support the ability to connect to the Internet and download content such as flash files (also known as widgets) and workflows that alter the configuration of the media processing devices. Each of the widgets and the workflows may also require access to the Internet for as a part of respective functional definition or purpose. The widgets and the workflows provide additional features and functionality to the media processing devices and as such, the capability to connect to the Internet and download the widgets and the workflows is intended to enrich the usage of the media processing devices.

A user of a media processing device may typically access a website on a web server for choosing a configuration amongst a list of configurations of the widgets and/or the workflows for configuring the media processing device for the user's specific use. The capability of the media processing device to connect to the Internet may then be utilized to download the chosen configuration from the web server and in effect add a new and unique capability to the media processing device. Since configurations are specific to a user and the media processing device, the web server may typically provide a mechanism for enabling the user to maintain a user's account separately from the other users. The user's account may further be password protected for ensuring a security of the user's account. Setting up the user's account may require the user to register in order to establish a unique user identification and password. Registration may further involve identifying one or more media processing devices to be associated to the user's account. The registration provides a method for a single user to uniquely manage a configuration of each of the one or more media processing device and for the web server to maintain a datastore for capturing and retaining a configuration for each of the one or more media processing devices. A media processing device may also need to be activated in a manner such that the media processing device is aware of being authorized and thus associated to a specific user account and that the media processing device is further allowed to download chosen configurations from the web server.

Solutions for enabling registration of the user's account and the subsequent activation of the media processing device, however, need to overcome several constraints. For instance, the user and the media processing device access the web server using separate and unrelated Internet connections. The user accesses the web server using a data processing device, such as a personal computer, for setting up and managing the user account. The media processing device may have to access the web server to retrieve configuration information and downloads specific to the media processing device and for activating the media processing device to the user's account. Further, any communication between the media processing device and the web server must be initiated from the media processing device, as attempts to connect to the media processing device from the web server may be prevented by firewalls as well as ongoing changes to an Internet Protocol (IP) address of the media processing device by routers and Internet Service Providers (ISPs). Also, a closed loop between the user, the media processing device and the web server is mandatory for enabling the media processing device to communicate with the web server with sufficient information for subsequent communications. The web server may then validate the media processing device as legitimate and may look up the information specific to the media processing device.

Such aforementioned constraints have been addressed by existing solutions such as a product known as “Chumby”, an Internet appliance relying on use of flash applets and configured with the capability of accessing content from the Internet and rendering the content to a Chumby touch panel in an interactive manner. On setting up a user account, the web server may typically provide a graphical sequence, also known as a bubble pattern, to the user, via web page on a data processing device. The user may place the Chumby in registration mode and manually enter the bubble pattern through the Chumby touch panel. The Chumby may then transmit the bubble pattern to the web server, which may then match the bubble pattern for creating an association between the user account and the Chumby appliance. On occurrence of mismatch of the bubble pattern, a numerical code, typically a device serial number may be provided by the web page. The user may then manually enter the numerical code on the Chumby and proceed with the association.

However, such a solution burdens the user with additional and manual tasks to complete the registration. Further, such solutions risk error scenarios since the bubble pattern and/or the numerical code is entered manually to complete the registration. Furthermore, such solutions are lengthy and cumbersome and as such have an effect of degrading the user experience.

Based on the foregoing, there is a need for activating the media processing device to the web server in a non-intrusive manner that precludes additional and manual tasks for the user for completing the registration. Further, there is a need for precluding a risk of error scenarios such as those introduced by manually entering the bubble pattern and/or the numerical code. Furthermore, there exists a need for activating the media processing device while providing an enhanced user experience.

### SUMMARY OF THE DISCLOSURE

In view of the foregoing disadvantages inherent in the prior art, the general purpose of the present disclosure is to provide a method and a computer program product for activating a media processing device to a web server by a data processing device to include all the advantages of the prior art, and to overcome the drawbacks inherent therein.

Accordingly, in one aspect the present disclosure provides a method for activating a media processing device to a web server by a data processing device. A device registration request is provided to the web server. The device registration request comprises information specific to the media processing device. An activation code is retrieved from the web server based on the information specific to the media processing device. The activation code is provided to the media processing device for triggering the activation of the media processing device. The activation code is forwarded by the media processing device to the web server and the media processing device is registered and activated on confirmation of the activation code by the web server.

Further, in another aspect, the present disclosure provides a computer program product embodied on a computer readable medium in a data processing device for activating a media processing device to a web server. The computer program product comprises a program module. The program module comprises instructions for providing a device registration request to the web server. The device registration request comprises information specific to the media processing device. The program module further comprises instructions for retrieving an activation code from the web server based on the information specific to the media processing device and providing the activation code to the media processing device for triggering the activation of the media processing device. The activation code is retrieved from the web server based on the information specific to the media processing device. The activation code is forwarded by the media processing device to the web server and the media processing device is registered and activated on confirmation of the activation code by the web server.

A utilization of the data processing device for retrieval of an activation code and the subsequent registration and activation based on the activation code precludes additional and manual tasks on the user, and as such provides a non-intrusive and automatic method of activation of the media processing device to the web server. Further, the activation code is forwarded by the media processing device to the web server, thereby precluding a risk of error scenarios such as those introduced by manually entering the bubble pattern and/or the numerical code. Furthermore, the minimal user intervention, reduced number of steps required for registration and the elimination of risking error scenarios enhances a user experience for activating the media processing device to the web server.

### BRIEF DESCRIPTION OF THE DRAWINGS

The above-mentioned and other features and advantages of this present disclosure, and the manner of attaining them, will become more apparent and the present disclosure will be better understood by reference to the following description of embodiments of the disclosure taken in conjunction with the accompanying drawings, wherein:

FIG. 1 is a schematic depiction of an exemplary environment in which various embodiments of the present disclosure may be practiced;

FIG. 2 is a schematic depiction of a flow diagram illustrating a method for activating a media processing device to a web server by a data processing device, embodying the present disclosure; and

FIG. 3 is a schematic depiction of a flow diagram illustrating another method for activating a media processing device to a web server by a data processing device, embodying the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including”, “comprising” or “having” and variations thereof herein is meant to encompass the items listed thereafter and equivalents thereof as well as additional items.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the present disclosure may be implemented in software. As such, it should be noted that a plurality of hardware and software-based devices, as well as a plurality of different structural components may be utilized to implement the present disclosure. Furthermore, and as described in subsequent paragraphs, the specific mechanical configurations illustrated in the drawings are intended to exemplify embodiments of the present disclosure and that other alternative mechanical configurations are possible.

The present disclosure provides a method and a computer program product for activating a media processing device to a web server by a data processing device. A device registration request is provided to the web server. The device registration request comprises information specific to the media processing device. An activation code is retrieved from the web server based on the information specific to the media processing device. The activation code is provided to the media processing device for triggering the activation of the media processing device. The activation code is forwarded by the media processing device to the web server and the media processing device is registered and activated on confirmation of the activation code by the web server.

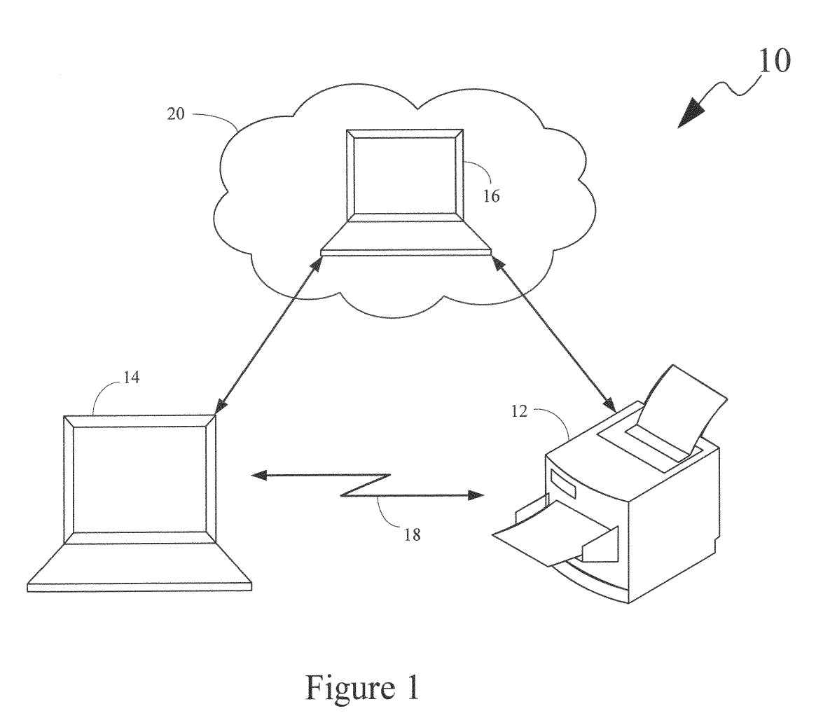

Referring now to the drawings, and particularly to FIG. 1, there is shown a schematic depiction of an environment 10 in which various embodiments of the present disclosure may be practiced. Environment 10 includes a media processing device 12, a data processing device 14, and a web server 16. Media processing device 12 may be, for example, an inkjet printer/copier, an electrographic printer/copier, a thermal transfer printer/copier or a so-called ‘all-in-one device’ that incorporates multiple functions, such as scanning, copying, and printing capabilities in one device. An example of data processing device 14 may include, but not limited to, a personal computer. Media processing device 12 communicates with data processing device 14 via a communication link 18. Communication link 18 facilitates electronic communication between media processing device 12 and data processing device 14, and may operate using a wired technology or a wireless technology. Media processing device 12 may communicate with data processing device 14 via a standard communication protocol, such as Ethernet or Institute of Electrical and Electronics Engineers (IEEE) 802.xx, or a NPA command language or any proprietary communication protocol.

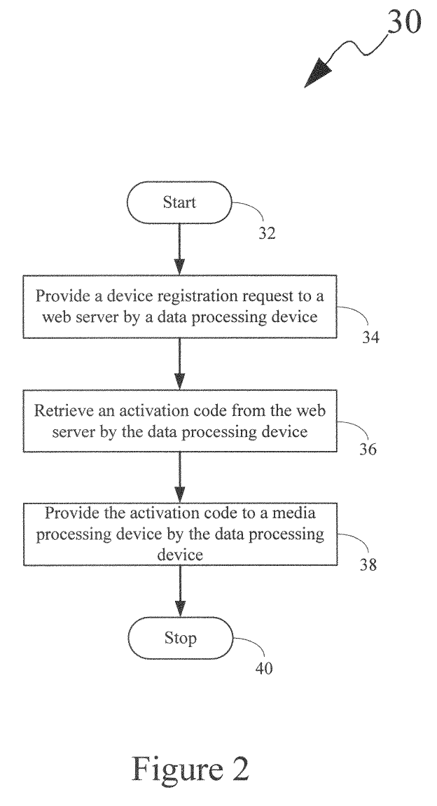

Media processing device 12 and data processing device 14 access web server 16 through a network 20. An example of network 20 may include but is not limited to the Internet. Web server 16 includes at least one website hosting content such as flash files (also known as widgets) and workflows capable of providing additional features and functionality to media processing device 12. The content may be downloaded into media processing device 12 based on a preference of a user of media processing device 12 for enhancing a capability of media processing device 12. Prior to downloading the content based on the preference of the user of media processing device 12, the user may need to link, i.e. associate media processing device 12 to the user. The user may utilize data processing device 14 to associate media processing device 12 to the user. On associating media processing device 12 to the user, media processing device 12 may be activated to web server 16 and the content may be downloaded into media processing device 12 for enhancing a capability of media processing device 12. The activation of media processing device 12 to web server 16 by data processing device 14 is explained in detail in conjunction with a flow diagram depicted in FIG. 2.

FIG. 2 is a schematic depiction of a flow diagram 30 illustrating a method for activating a media processing device, such as media processing device 12, to a web server, such as web server 16, by a data processing device, such as data processing device 14, in accordance with an embodiment of the present disclosure. A user of the media processing device selects the media processing device to be activated using the data processing device and the data processing device obtains information about the media processing device using a communication link, such as the communication link 18. The method starts at 32. At 34, a device registration request is provided to the web server by the data processing device. The device registration request comprises information specific to the media processing device. Examples of the information specific to the media processing device may include a serial number of the media processing device, a Media Access Control (MAC) address of the media processing device or any such information. At 36, an activation code based on the information specific to the media processing device is retrieved from the web server by the data processing device. It will be evident to a person skilled in the art that the activation code may be any token unique to the media processing device to be activated. At 38, the activation code is provided to the media processing device for triggering the activation of the media processing device. The method ends at 40. At 40, the activation code is forwarded by the media processing device to the web server and the media processing device is registered and activated on confirmation of the activation code by the web server.

In an embodiment of the present disclosure, the device registration request further comprises user information specific to a user of the media processing device. The user information may typically include information such as a user name, a user password, and the like. The web server may create a user account based on the user information prior to retrieval of the activation code by the data processing device. On creation of the user account, the web server may generate the activation code unique to the media processing device based on the information specific to the media processing device included in the device registration request. The activation code may then be retrieved by the data processing device and provided to the media processing device. The media processing device may forward the activation code to the web server. In an embodiment of the present disclosure, the media processing device forwards at least one of a serial number of the media processing device and a Media Access Control (MAC) address of the media processing device to the web server along with the activation code. The web server may then match the activation code provided by the media processing device to the activation code provided by the web server to the data processing device. On confirmation of the activation code, the web server may then associate the media processing device to the user account.

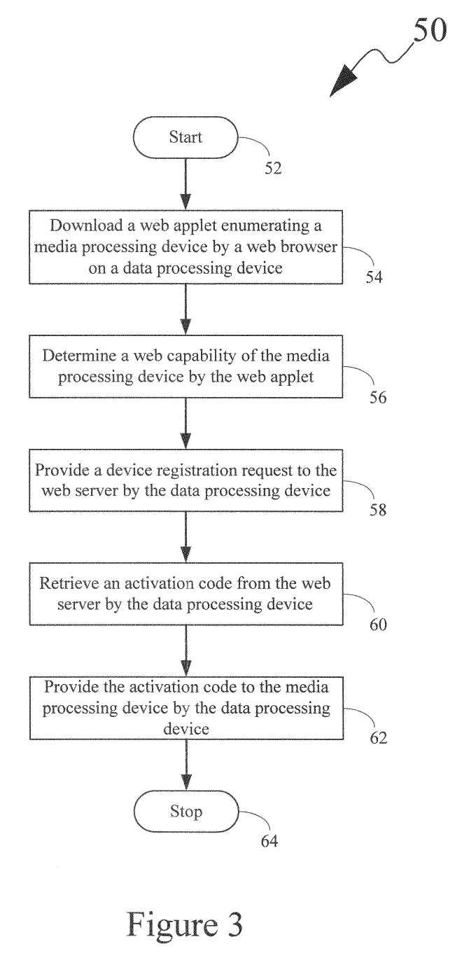

In an embodiment of the present disclosure, the activation of the media processing device authorizes the media processing device to communicate with the web server. The media processing device may then proceed to download content such as flash files and workflows from the web server, and, accordingly alter a configuration of the media processing device based on a preference of a user of the media processing device. In an embodiment of the present disclosure, the activation code corresponding to the media processing device is stored in the web server. For subsequent communications with the web server, the media processing device may utilize the activation code for providing valid verification and may then access the content hosted on the web server. In an embodiment of the present disclosure, the activation code may be utilized as a means of authorization till a deactivation of the media processing device is initiated. On subsequent activation of the media processing device, the activation code may be re-used as a means of authorization for communicating with the web server. The activation of the media processing device to the web server is further explained in conjunction with FIG. 3.

FIG. 3 is a schematic depiction of a flow diagram 50 illustrating a method for activating a media processing device, such as media processing device 12, to a web server, such as web server 16, by a data processing device, such as data processing device 14 in accordance with another embodiment of the present disclosure. The method starts at 52. At 52, a user of the media processing device launches a web browser application on the data processing device. At 54, the web browser downloads a web applet which enumerates the media processing device. At 56, the web applet determines a capability of the media processing device to connect to the Internet. At 58, a device registration request is provided to the web server by the data processing device. The device registration request comprises information specific to the media processing device. Examples of the information specific to the media processing device may include a serial number of the media processing device, a Media Access Control (MAC) address of the media processing device or any such information. In an embodiment of the present disclosure, the information specific to the media processing device may include at least one of a serial number of the media processing device and a Media Access Control (MAC) address of the media processing device. At 60, an activation code based on the information specific to the media processing device is retrieved from the web server by the data processing device. At 62, the activation code is provided to the media processing device for triggering the activation of the media processing device. The method ends at 64. At 64, the activation code is forwarded by the media processing device to the web server and the media processing device is registered and activated on confirmation of the activation code by the web server.

As explained in conjunction with FIG. 2, the activation of the media processing device authorizes the media processing device to communicate with the web server. The media processing device may utilize the activation code for providing valid verification for subsequent communications with the web server.

Utilizing a data processing device, such as data processing device 14, provides an effective mechanism for activating a media processing device, such as media processing device 12, to a web server, such as web server 16. Moreover, a generation of an activation code based on information about the media processing device and the subsequent registration and activation based on the activation code precludes additional and manual tasks on the user, and as such provides a non-intrusive and automatic method of activation of the media processing device to the web server. Further, the activation code is forwarded by the media processing device to the web server, thereby precluding a risk of error scenarios such as those introduced by manually entering a bubble pattern and/or a numerical code. Furthermore, the minimal user intervention, reduced number of steps required for registration and the elimination of risking error scenarios enhances a user experience for activating the media processing device to the web server.

Also, as explained above, the data processing device may be used for activation purposes only, and, the media processing device may communicate directly with the web server for subsequent communications using the activation code. Moreover, communication between the data processing device and the media processing device occur through Application Programming Interfaces (APIs) provided by an Operating System (OS) hosted by the data processing device and, as such, no additional software is required to be included in the data processing device.

The embodiments of the present disclosure may be in the form of a computer program product embodied on a computer readable medium in a data processing device for activating a media processing device, such as media processing device 12, to a web server. Embodiments of the present disclosure may also be embodied in the form of a program module containing instructions embodied in tangible media, such as floppy diskettes, CD-ROMs, hard drives, or any other computer-readable storage medium, wherein, when the program module is loaded into and executed by a computer, the computer becomes an apparatus for practicing the present disclosure. The program module includes instructions for providing a device registration request to the web server. The device registration request comprises information specific to the media processing device. The program module further comprises instructions for retrieving an activation code from the web server based on the information specific to the media processing device and providing the activation code to the media processing device for triggering the activation of the media processing device. The activation code is retrieved from the web server based on the information specific to the media processing device. The activation code is forwarded by the media processing device to the web server and the media processing device is registered and activated on confirmation of the activation code by the web server.

As explained in conjunction with FIG. 2, the device registration request may further comprise user information specific to a user of the media processing device. The web server may create a user account based on the user information prior to retrieval of the activation code to the data processing device. On creation of the user account, the web server may generate the activation code unique to the media processing device based on the information specific to the media processing device included in the device registration request. The activation code may then be retrieved by the data processing device and provided to the media processing device. The media processing device may forward the activation code to the web server. In an embodiment of the present disclosure, the media processing device forwards at least one of a serial number of the media processing device and a Media Access Control (MAC) address of the media processing device to the web server along with the activation code. The web server may then link, i.e. associate the media processing device to the user account on confirmation of the activation code. The activation of the media processing device authorizes the media processing device to communicate with the web server.

It will be apparent to a person skilled in the art that the present disclosure as described above, may be embodied in the form of computer program code, for example, whether stored in a storage medium, loaded into and or executed by a computer, or transmitted over some transmission medium, such as over electrical wiring or cabling through fiber optics, or via electromagnetic radiation, wherein, when the computer program code is loaded into and executed by a computer, the computer becomes an apparatus for practicing the present disclosure. When implemented on a general-purpose microprocessor, the computer program code segments configure the microprocessor to create specific logic circuits.

The foregoing description of several methods and an embodiment of the present disclosure have been presented for purposes of illustration. It is not intended to be exhaustive or to limit the present disclosure to the precise steps and/or forms disclosed, and obviously many modifications and variations are possible in light of the above description. It is intended that the scope of the present disclosure be defined by the claims appended hereto.

What is claimed is:

1. A method for activating a media processing device to a web server by a data processing device, the method comprising:
providing a device registration request to the web server, the device registration request comprising information specific to the media processing device;
retrieving an activation code from the web server based on the information specific to the media processing device; and
providing the activation code to the media processing device for triggering the activation of the media processing device,
wherein the activation code is forwarded by the media processing device to the web server, and,
wherein the media processing device is registered and activated on confirmation of the activation code by the web server.

2. The method of claim 1 wherein the device registration request further comprises user information specific to a user of the media processing device.

3. The method of claim 2 wherein the web server creates a user account based on the user information prior to retrieval of the activation code by the data processing device.

4. The method of claim 3 wherein the media processing device is associated to the user account by the web server on confirmation of the activation code.

5. The method of claim 1 wherein the activation of the media processing device authorizes the media processing device to communicate with the web server.

6. The method of claim 1 wherein the media processing device forwards at least one of a serial number of the media processing device and a Media Access Control (MAC) address of the media processing device to the web server along with the activation code.

7. A computer program product embodied on a computer readable medium in a data processing device for activating a media processing device to a web server, the computer program product comprising a program module having instructions for:
providing a device registration request to the web server, the device registration request comprising information specific to the media processing device;
retrieving an activation code from the web server based on the information specific to the media processing device; and
providing the activation code to the media processing device for triggering the activation of the media processing device,
wherein the activation code is forwarded by the media processing device to the web server, and,
wherein the media processing device is registered and activated on confirmation of the activation code by the web server.

8. The computer program product of claim 7 wherein the device registration request further comprises user information specific to a user of the media processing device.

9. The computer program product of claim 8 wherein the web server creates a user account based on the user information prior to retrieval of the activation code by the data processing device.

10. The computer program product of claim 9 wherein the media processing device is associated to the user account by the web server on confirmation of the activation code.

11. The computer program product of claim 7 wherein the activation of the media processing device authorizes the media processing device to communicate with the web server.

12. The computer program product of claim 7 wherein the media processing device forwards at least one of a serial number of the media processing device and a Media Access Control (MAC) address of the media processing device to the web server along with the activation code.
